(19) United States
(12) Patent Application Publication
(10) Pub. No.: US 2015/0213680 A1
(43) Pub. Date: Jul. 30, 2015

(54) METHOD AND SYSTEM FOR AUTOMATED SELECTION OF TARGETED PRIZES

(71) Applicant: SEARS BRANDS, L.L.C., Hoffman Estates, IL (US)

(72) Inventor: Frederick W. Skoler, Barrington, IL (US)

(73) Assignee: SEARS BRANDS, L.L.C., Hoffman Estates, IL (US)

(21) Appl. No.: 14/166,064

(22) Filed: Jan. 28, 2014

(51) Int. Cl. G07F 17/32

(52) U.S. Cl. CPC G07F 17/3244

(57) ABSTRACT

Systems and methods support automated targeted selection of product items and management of post-award delivery of prizes for promotional activities such as sweepstakes, contests, giveaways, and/or instant wins in an e-commerce environment. Information identifying consumer trends enables dynamic selection of promotional items having a high value proposition for target participants of a promotional activity, resulting in increased consumer participation, reduced prize fulfillment issues, improved ease of use, and lower cost per promotional activity.

### FIELD OF THE INVENTION

Certain embodiments of the present invention relate to systems and methods for running various forms of promotions by a merchant or business. More specifically, certain aspects of the present invention relate to systems and methods that support automated targeted selection of product items and management of post-award delivery of prizes for promotional activities such as for sweepstakes, contests, giveaways, and/or instant wins in an e-commerce environment.

### BACKGROUND OF THE INVENTION

Companies wishing to engage consumers, promote products, and increase sales may employ promotional activities such as sweepstakes, contests, giveaways, and/or instant wins. The setup of such promotional activities may involve scheduling of each promotion activity, identification of target participants, determination and publication of rules and legal requirements, acquisition of prizes to be awarded, advertising to the individuals in the target demographic, qualification of prospective participants, determination of the winner(s) of each promotion, and delivery or fulfillment of prizes to the winners. The process of setting up and running each promotional activity is time consuming, expensive, and subject to numerous sources of errors.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and method that supports automated targeted selection of items used as prizes by a promotions platform, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is an illustration of exemplary computer network in which a representative embodiment of the present invention may be practiced.

FIG. 2 illustrates an example division of functionality for an e-commerce platform that may correspond to, for example, functionality present in the host system of FIG. 1, in accordance with a representative embodiment of the present invention.

FIG. 3 is a flowchart of an exemplary method of operating a system such as, for example, the prize selection system of FIG. 2 that supports automated targeted prize selection, in accordance with a representative embodiment of the present invention.

FIG. 4 illustrates a screen image showing an exemplary user interface that enables specification of prize selection parameters for use by a prize selection system such as the prize selection system of FIG. 2, in accordance with a representative embodiment of the present invention.

### DETAILED DESCRIPTION OF THE INVENTION

Aspects of the present invention relate to systems and methods for running various forms of promotions by a merchant or business. More specifically, certain aspects of the present invention relate to systems and methods that support automated targeted selection of product items and management of post-award delivery of prizes for promotional activities such as for sweepstakes, contests, giveaways, and/or instant wins in an e-commerce environment.

The following description of example methods and apparatus is not intended to limit the scope of the description to the precise form or forms detailed herein. Instead the following description is intended to be illustrative so that others may follow its teachings.

The terms “customer,” “consumer,” “user,” and “end-user” may be used herein interchangeably to refer to a potential or existing purchaser of products and/or services of a merchant or business.

The term “demographics” may be used herein to refer to the quantifiable statistics of a given population. The terms “target demographic” and “target market” may be used interchangeably herein to refer to a group of customers towards which a business has decided to aim its marketing efforts and ultimately its merchandise.

The term “loyalty program” may be used herein to refer to a structured marketing effort that rewards, and therefore encourages, loyal buying behavior that is potentially beneficial to the business or firm operating or sponsoring the loyalty program. The term “member” may be used herein to refer to those consumers that have provided personal information to an operator or sponsor of a loyalty program in order to gain access to benefits provided by the loyalty program.

The term “social network” may be used herein to refer to a network of family, friends, colleagues, and other personal contacts, or to an online community of such individuals who use a website or other technologies to communicate with each other, share information, resources, etc.

As utilized herein, the terms “exemplary” or “example” means serving as a non-limiting example, instance, or illustration. As utilized herein, the term “e.g.” introduces a list of one or more non-limiting examples, instances, or illustrations.

The disclosed methods and systems may be part of an overall shopping experience system created to enhance the consumer shopping event. For example, the disclosed system may be integrated with the customer's reward system, the customer's social network (e.g., the customer can post their shopping activity conducted through the system to their social network), the customer's expert system, digital/mobile applications, shopping history, wish list, location, merchandise selections, or the like. However, the system disclosed may be fully and/or partially integrated with any suitable shopping system as desired, including those not mentioned and/or later designed.

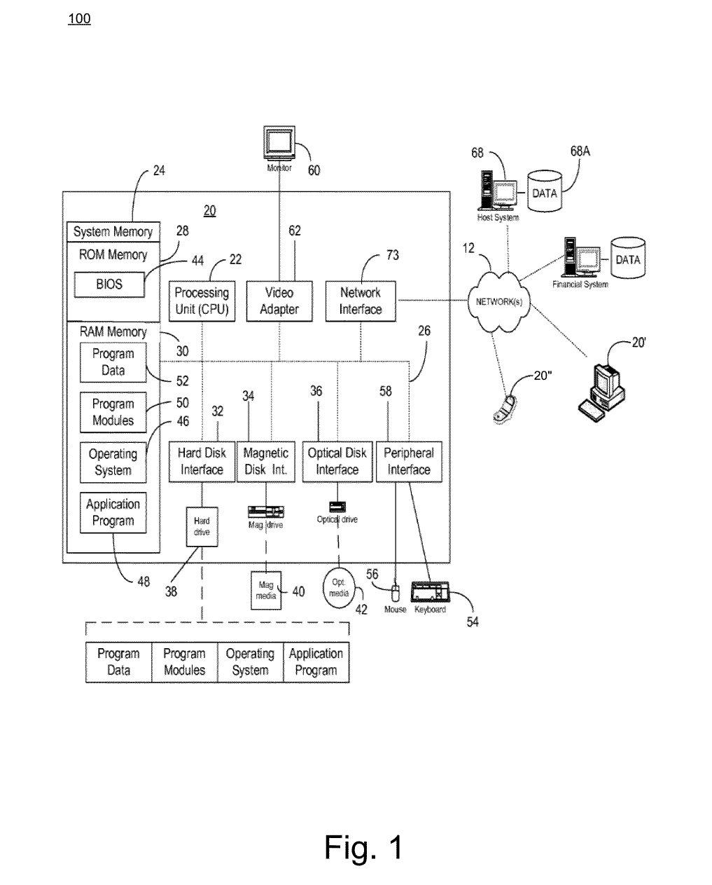

FIG. 1 is an illustration of exemplary computer network in which a representative embodiment of the present invention may be practiced. The following discloses various example systems and methods for, by way of example and not limitation, engaging consumers in promotional activities such as, for example, sweepstakes, contests, giveaways, and/or instant wins operated by or for a merchant or business, where those promotional activities may reward members and/or participants with prizes or awards. Referring now to FIG. 1, a processing device 20″, illustrated in the exemplary form of a mobile communication device, a processing device 20′, illustrated in the exemplary form of a computer system, and a processing device 20 illustrated in schematic form, are shown. Each of these devices 20, 20′, 20″ are provided with executable instructions to, for example, provide a means for a customer, e.g., a user, a customer or consumer, etc., or a sales associate, a customer service agent, and/or others to access a host system 68 and, among other things, be connected to a content management system, an electronic publication system, a hosted social networking site, a user profile, a store directory, and/or a sales associate. Generally, the computer executable instructions reside in program modules which may include routines, programs, objects, components, data structures, etc. that perform particular tasks or implement particular abstract data types. Accordingly, the processing devices 20, 20′, 20″ illustrated in FIG. 1 may be embodied in any device having the ability to execute instructions such as, by way of example, a personal computer, mainframe computer, personal-digital assistant (“FDA”), cellular telephone, tablet, e-reader, smart phone, or the like. Furthermore, while described and illustrated in the context of a single processing device 20, 20′, 20″, the various tasks described hereinafter may be practiced in a distributed environment having multiple processing devices linked via a local or wide-area network whereby the executable instructions may be associated with and/or executed by one or more of multiple processing devices.

For performing the various tasks in accordance with the executable instructions, the example processing device 20 includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer-readable instructions, data structures, program modules and other data for the processing device 20. Other types of non-transitory computer-readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 are provided. While not illustrated, other input devices may include a microphone, a joystick, a game pad, a scanner, a camera, touchpad, touch screen, etc. These and other input devices are typically connected to the processing unit 22 by means of an interface 58 which, in turn, is coupled to the bus 26. Input devices may be connected to the processor 22 using interfaces such as, for example, a parallel port, game port, FireWire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as, for example, speakers, cameras, printers, or other suitable device.

As noted, the processing device 20 may also utilize logical connections to one or more remote processing devices, such as the host system 68 having associated data repository 68A. In this regard, while the host system 68 has been illustrated in the exemplary form of a computer, the host system 68 may, like processing device 20, be any type of device having processing capabilities. Again, the host system 68 need not be implemented as a single device but may be implemented in a manner such that the tasks performed by the host system 68 are distributed amongst a plurality of processing devices/databases located at different geographical locations and linked through a communication network. Additionally, the host system 68 may have logical connections to other third party systems via a network 12, such as, for example, the Internet, LAN, MAN, WAN, cellular network, cloud network, enterprise network, virtual private network, wired and/or wireless network, or other suitable network, and via such connections, will be associated with data repositories that are associated with such other third party systems. Such third party systems may include, without limitation, systems of banking, credit, or other financial institutions, systems supporting e-commerce including systems of third party providers of goods and/or services, systems of shipping/delivery companies, media content providers, systems supporting social networks, document storage systems, etc.

For performing tasks as needed, the host system 68 may include many or all of the elements described above relative to the processing device 20. In addition, the host system 68 would generally include executable instructions for, among other things, coordinating storage and retrieval of documents; maintaining social network storage of a shopping list; receiving a location of a customer via a mobile device; maintaining maps and layouts of buildings and geographic areas; calculating directions or routes within buildings and geographic areas; searching, retrieving, and analyzing web-based content; managing operating rules and communication with user devices used by participants in a multiplayer consumer game, for receiving a request for a service call center connection from either a customer or a sales associate; routing a received request via a distributed mobile video call center; and providing a service call infrastructure for providing the requestor with a distributed customer service experience.

Communications between the processing device 20 and the host system 68 may be exchanged via a further processing device, such as a network router (not shown), that is responsible for network routing. Communications with the network router may be performed via a network interface component 73. Thus, within such a networked environment, e.g., the Internet, World Wide Web, LAN, cloud, or other like type of wired or wireless network, program modules depicted relative to the processing device 20, or portions thereof, may be stored in the non-transitory computer-readable memory storage device(s) of the host system 68 and processing devices 20, 20′ and 20″.

A representative embodiment of the present invention may be seen in a system or method for automatically selecting prizes to be awarded by an e-commerce promotions platform used in administering e-commerce promotions, such as sweepstakes, contests, giveaways, and/or instant wins, as further described below. A system and/or method for automatic prize selection in accordance with a representative embodiment of the present invention may be operated and/or sponsored by a merchant or business.

A merchant or business wishing to use promotional activities in which prizes are awarded such as, by way of example and not limitation, sweepstakes, contests, giveaways, and/or instant wins, needs to have ways of managing a number of aspects of such an activity. The preparation for operating each instance of a promotional activity, such as the examples mentioned above, may involve, for example, ensuring that all applicable laws and requirements are known, and that all rules of the promotional activity are clearly defined. The number of occurrences, the scheduling of each occurrence, and the various costs associated with each promotional activity need to be determined. The characteristics of the individuals that the merchant or business wishes to attract as participants in the promotional activity, the target market or demographic, should be identified, and a suitable prize that is appropriate and of particular interest to individuals in the target market, and that meets cost objectives for the promotional activity needs to be chosen, to help make the promotional activity as attractive as possible to the target participants. The details of each promotional activity, including the applicable rules, terms and conditions, and accurate details of the prize(s) need to be shared with the target participants. The winner of each promotional activity is then identified, and the prize designated for each promotional activity, along with any documentation (e.g., forms relating to taxes due) needs to be delivered to the respective winner. Operation of a large number of promotional activities may consume considerable resources in terms of both human capital and monetary cost to the sponsoring merchant(s) or business. Further details describing systems and methods supporting the operation of promotional activities such as contests and sweepstakes may be found, for example, in U.S. patent application Ser. No. 13/956,978, titled “Contests and Sweepstakes,” filed Aug. 1, 2013, and U.S. Provisional Patent Application No. 61/842,353, titled “Methods and Systems for a Sweepstakes Platform,” filed Jul. 2, 2013, the complete subject matter of each of which is hereby incorporated herein, by reference.

A representative embodiment of the present invention may be used as a resource to provide automated targeted prize selection and delivery based on targeted demographic data analysis for contests, sweepstakes, and other forms of promotional activities, to enable the running of long-standing, self-servicing sweepstakes and contests. Coupled with the use of product fulfillment systems providing a selection from a large array of products, a representative embodiment of the present invention enables a novel production flow and user experience that assures prize selection and delivery in a trustworthy automated framework. The automated selection of prizes enables recurring launches of sweepstakes, contests, and other forms of promotional activities that may be set to launch as often as every day, as desired, and may run consecutively for an operator-defined number of days, without operator intervention. The targeted prizing may be automated to select from currently trending products, to assure that the selected prizes maintain relevance to seasonal and changing consumer sentiment, and to provide a high value proposition to those individuals within the target demographic.

A representative embodiment of the present invention may permit operator targeting of promotional activities such as sweepstakes, contests, giveaways, and instant wins at a one-off as well as a recurring schedule, according to selected target demographics, frequency, and cost objectives. A prize selection system in accordance with a representative embodiment of the present invention may receive attributes or characteristics of the target market of the promotional activity from those operating/sponsoring the promotional activity. Examples of such attributes of individuals in the target market may include, by way of example and not limitation, age, gender, stage of life, residence geographic location, and other attributes. Products used as promotional prizes may be dynamically selected from an inventory of available products, determined by consumer shopping and social e-commerce activity monitoring to be of greatest interest to consumers in the target demographic, from a product category and at an item cost chosen by the operator of the promotional activity. In a representative embodiment of the present invention, a product to be used as a prize for a promotional activity may be selected based on real-time information that identifies products having a high value proposition for the target demographic, using information about product sales and on-line consumer interest (e.g., consumer searches, on-line and brick-and-mortar purchase levels, and information (e.g., reviews and comments) from social networks and news sources).

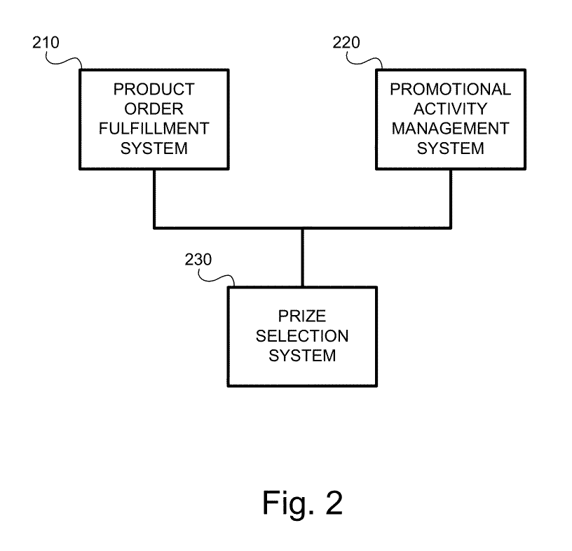

FIG. 2 illustrates an example division of functionality for an e-commerce platform that may correspond to, for example, functionality present in the host system 68 of FIG. 1, in accordance with a representative embodiment of the present invention. The example of FIG. 2 includes a product order fulfillment system 210, a promotional activity management system 220, and a prize selection system 230. The functionality of the product order fulfillment system 210, the promotional activity management system 220, and the prize selection system 230 may be supported by one or more processors in a single computing system, may be divided among multiple such computing systems located in close proximity or remotely from one another, and may be partitioned in any suitable manner when implemented across such multiple computing systems. As illustrated in FIG. 2, the product order fulfillment system 210, the promotional activity management system 220, and the prize selection system 230 are communicatively coupled to one another.

The product order fulfillment system 210 may, for example, support a network accessible retail web site that enables consumers to shop online (e.g. via the Internet). Consumers may access the product order fulfillment system 210 using, for example, browser or any other suitable software on a smart phone, an e-reader, or a tablet, laptop, netbook, or desktop personal computer (PC) equipped to communicate via a wireless or wired communication link. The product order fulfillment system 210 may permit the consumer to access information about a number of products such as, by way of example and not limitation, product specifications, product images, product reviews, product pricing, product warrantee information, product availability, and information about the supplier of products. The product order fulfillment system 210 may also permit a purchaser to specify the handling of the product after purchase. For example, the purchaser of a product may select an option for shipping the product to a specified address such as, for example, to their home, office, or to the home or office of another. The product order fulfillment system may also allow the purchaser to specify that the product is to be held by the merchant for later delivery such as, for example, for pickup at a particular physical location of the merchant that operates or sponsors the product order fulfillment system 210.

In addition, the product order fulfillment system 210 may support a social network for customers of the merchant that operates, sponsors, or partners with the operator of the product order fulfillment system 210. Access to the social network may, for example, be given to those consumers that become members of a loyalty program operated by the merchant that operates or sponsors the product order fulfillment system 210. A consumer may become a member of such a loyalty program by providing personal information about themselves such as, by way of example and not limitation, gender; age; marital status; stage of life information that identifies, by way of example and not limitation, members that are single, newly married, starting a family, raising children at varies ages, “empty-nesters,” and/or retired; residence address; email address; telephone/cellphone number(s); credit card information; and information about friends and family. The consumer may also provide personal information about their preferred products, brands, manufacturers, designers, styles, colors, and sizes; and information about their preferred “brick-and-mortar” locations of the merchant, or of partners of the merchant operating or sponsoring the product order fulfillment system 210. Such information provided by the member may be collected and maintained in a system such as, for example, a data repository 68A of the host system 68 of FIG. 1. Such a loyalty program may provide access to particular benefits such as, by way of example and not limitation, special offers, discounts, coupons, early access to sales, and various other forms of special recognition or benefit of their membership. Members may also be permitted to participate in promotional activities such as, by way of example and not limitation, contests, sweepstakes, giveaways, and instant wins. A system such as the product order fulfillment system 210 may, for example, enable the members of the loyalty program to communicate with one another, and each member of the loyalty program may be permitted to identify loyalty program members that are part of their own personal social network and to engage in communication and activities with members of their personal social network. Some of the activities may be shopping related, while other activities may be unrelated to shopping.

The product order fulfillment system 210 may permit a member of the loyalty program to perform certain actions such as, by way of example and not limitation, submit one or more reviews of products; post messages to other members or the loyalty program or their own personal social network; express feelings about or relationships with a product by clicking on/selecting an icon associated with a product such as, by way of example and not limitation, “Like,” “Want,” or “Have”; and create one or more catalogs of products of interest to the member (e.g., that the member likes, wants, or has). The member may also be permitted to create a step-by-step project accessible to other members of the loyalty program; and to request to “follow” selected activities of, for example, another member of the loyalty program or celebrities associated with the merchant. The product order fulfillment system 210 may collect information about such activities of members of the loyalty program, and may analyze the collected information to determine consumer trends such as, for example, interest in particular products, designers, styles, well-known personalities or celebrities; and stage of life information that identifies, by way of example and not limitation, consumers that are single, newly married, starting a family, raising children at varies ages, “empty-nesters,” and/or retired.

The promotional activity management system 220 may, for example, be a system supporting various activities surrounding the operation of promotional activities such as, for example, contests, sweepstakes, giveaways, and instant wins. Such a system may enable the scheduling of such promotional activities by a merchant or sponsor, including the specification of start and end dates/times, the type of promotional activity (e.g., sweepstakes, contest, giveaway, or instant win), whether the prize to be awarded is in the form of loyalty program reward points or is what may be referred to herein as a “premium” prize. A system such as the promotional activity management system 220 of FIG. 2 may supervise consumer qualification to participate in promotional activities by monitoring the completion of member activities required for entry. A system such as the promotional activity management system 220 may also track entries of qualified participants, select the winner of each promotional activity, and arrange for delivery of the associated prize to the winner.

In some representative embodiments of the present invention, the merchant or sponsor of a promotional activity may interface with the promotional activity management system 220 using a web site accessible via the Internet, for the complete scheduling, set up, and operation of a promotional activity, and may provide information used by a prize selection system such as that described herein for automated targeted selection of prizes for such promotional activities. Examples of some types of promotional activities for engaging consumers such as sweepstakes and contests may be found in U.S. patent application Ser. No. 13/956,978, titled “Contests and Sweepstakes,” filed Aug. 1, 2013. Additional details of an example platform supporting management and administration of such promotional activities may be found in U.S. Provisional Patent Application No. 61/842,353, titled “Methods and Systems for a Sweepstakes Platform,” filed Jul. 2, 2013. The complete subject matter of U.S. patent application Ser. No. 13/956,978 and U.S. Provisional Patent Application No. 61/842,353, are hereby incorporated herein, by reference.

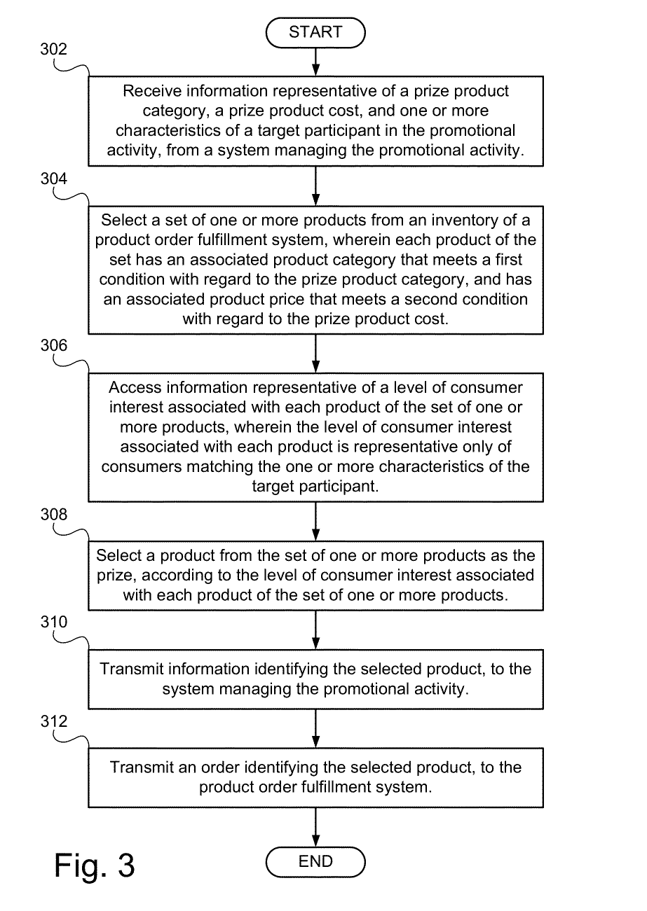

The prize selection system 230 of FIG. 2 may leverage the available inventory of an existing product order fulfillment system, such as the product order fulfillment system 210 of FIG. 2, as a “prize pool.” Information about consumer shopping activity and product trends may be shared by the product order fulfillment system 210 with the prize selection system 230, enabling the prize selection system 230 to select products that are targeted at a specific target market and within a specific prize price objective, allowing a representative embodiment of the present invention to offer product prize selections having a high value proposition or attractiveness to members of specific groups of consumers, while meeting cost objectives of the merchant or sponsor of the promotional activity. Additional details of the functionality of a prize selection system in accordance with a representative embodiment of the present invention will now be described with respect to FIG. 3.

FIG. 3 is a flowchart of an exemplary method of operating a system such as, for example, the prize selection system 230 of FIG. 2 that supports automated targeted prize selection, in accordance with a representative embodiment of the present invention. The following discussion of the method of FIG. 3 may refer to elements of FIGS. 1 and 2. It should be noted that various aspects of the functionality described with respect to the blocks of the example of FIG. 3 may be shifted among the blocks, and may be performed by entities of the example of FIG. 2 other than those identified below, without departing from the spirit of the present invention.

The method of FIG. 3 begins at block 302, where a system performing the actions of the method such as, for example, the host system 68 of FIG. 1, may receive information representative of a prize product category, a prize product cost, and one or more characteristics of a target participant (i.e., target demographics) in the promotional activity, from a system managing the promotional activity. In a representative embodiment of the present invention, the information representative of the prize product category, the prize product cost, and the one or more characteristics of a target participant may be provided to the system managing the promotional activity (e.g., promotional activity management system 220 of FIG. 2) by an operator/employee of the merchant or business sponsoring the promotional activity.

In some representative embodiments of the present invention, the prize product category may be representative of products of a particular department of the merchant or business sponsoring the promotional activity. Possible examples of such departments may include, by way of example and not limitation, “Appliances,” “Automotive and Tires,” “Baby,” “Back-to-School,” “Beauty and Health,” “Bed, Bath, and Home,” “Books and Magazines,” “Clothing,” “Shoes,” “Jewelry,” “Electronics and TVs,” “Fitness and Sports,” “Food and Grocery,” “Lawn and Garden,” “Movies, Music, and Gaming,” “Outdoor Living,” “Tool and Do-It-Yourself,” and “Toys and Games.” In other representative embodiments of the present invention, the prize product category may, for example, be representative of types or groups of products within a particular department of the merchant or business. Examples of types or groups of products within an “Appliance” department of a merchant may include, by way of example and not limitation, “Refrigerators,” “Electric Ranges,” “Wall Ovens,” “Cooktops,” “Washers,” “Dryers,” “Dishwashers,” “Heating,” “Humidifiers,” “Air Conditioners,” “Vacuums and Floor Care,” “Microwaves,” “Water Heaters,” “Small Kitchen Appliances,” “Sewing Machines,” and “Air Purifiers.”

In a representative embodiment of the present invention, the information representative of prize product cost may be, for example, a price range within which a product cost must lie for the product to be selected as a prize. In various representative embodiments of the present invention, the one or more characteristics of the target participant may include, by way of example and not limitation, gender; age; marital status; and stage of life information that identifies, by way of example and not limitation, consumers that are single, newly married, starting a family, raising children at varies ages, “empty-nesters,” and/or retired. The one or more characteristics of the target participant may also include, by way of example and not limitation, residence geographic address or location; credit card information; information about friends and family; information about their preferred products, brands, manufacturers, designers, styles, colors, and sizes; and information about their preferred “brick-and-mortar” location(s) of the merchant, or of partners of the merchant operating or sponsoring the product order fulfillment system 210 of FIG. 2.

At block 304, the system may select a set of one or more products from an inventory of a product order fulfillment system, where each product of the set has an associated product category that meets a first condition with regard to the prize product category, and has an associated product price that meets a second condition with regard to the prize product cost. Such a product order fulfillment system may, for example, correspond to the product order fulfillment system 210 of FIG. 2. The first condition for selection of a potential prize product from those available in the inventory may include, for example, determination that the product category of a product from the inventory matches the prize product category received by the prize selection system. The second condition for selection of a product may include, for example, determination that the product price of a product from the inventory is with a range of costs represented by the received prize product cost. In this manner, a system in accordance with a representative embodiment of the present invention may create a set of one or more products selected from the inventory of a product order fulfillment system in which the products are determined to be products in the specified prize product category, and within the specified prize product cost.

At block 306, the method may direct the system (e.g., the prize selection system 230) to access information representative of a level of consumer interest associated with each product of the set of one or more products. In a representative embodiment of the present invention, the level of consumer interest associated with each product may be representative only of the consumers matching the one or more characteristics of the target demographic. In a representative embodiment of the present invention, information representative of a level of consumer interest associated with various products may be collected and maintained by a system such as, for example, the product order fulfillment system 210 of FIG. 2, described above.

Then, at block 308, a system in accordance with the present invention may select a product as the prize product, from the set of one or more products, according to the level of consumer interest associated with each product of the set of the one or more products. For example, the system (e.g., the prize selection system 230 of FIG. 2) may select a prize for a promotional activity targeted at particular demographic from a set of products from a particular product category in a certain range of product cost, using the level of consumer interest associated with products shown to be of interest to other consumers with similar demographics. In a representative embodiment of the present invention, the level of consumer interest of products in the particular product category matching the prize product category and having a product cost in the particular range represented by the prize product cost may be analyzed to find that product most attractive to the target demographic of the promotional activity. In this manner, a representative embodiment of the present invention attempts to maximize the likelihood of participation in the promotional activity of consumers in the target demographic.

At block 310, a system performing the method of FIG. 2 may transmit information identifying the selected product, to the system managing the promotional activity such as, for example, the promotional activity management system 220 of FIG. 2. In a representative embodiment of the present invention, transmitting information that identifies the selected prize product to the system that manages the promotional activity enables that system to, by way of example and not limitation, generate print and/or online advertisements and notices of the promotional activity including, for example, pictures, technical details, product specifications (e.g., dimensions, weight, color, included accessories), and value of the prize product. Such information also enables the system managing the promotional activity to generate any statement(s) of legal requirements and “terms and conditions” related to the selected prize product, for inclusion in any advertisements, notices, or other publications or documents in which such information must appear.

Finally, at block 312, the method of FIG. 2 may direct a system to transmit an order for purchase of the selected product, to a product order fulfillment system such as, for example, the product order fulfillment system 210 of FIG. 3, described in detail above. Transmitting an order for purchase of the selected prize product to a system having known available inventory of the selected prize product and capability to deliver the selected prize product enables a representative embodiment of the present invention to reliably acquire and deliver the selected prize for the promotional activity. In some representative embodiments of the present invention, the system may transmit the order for purchase along with an indication that the product is to be held for delivery by the product order fulfillment system, until a later point in time. That is, a prize selection system in accordance with the present invention may not only identify the selected product to the product order fulfillment system, but may also request that the ordered product be reserved for later delivery, i.e., when the winner of the associated promotional activity has been identified. In one representative embodiment of the present invention, information identifying the winner of a promotional activity may, for example, be provided by a system managing the promotional activity (e.g., the promotional activity management system 220 of FIG. 2) directly to a product order fulfillment system (e.g., the product order fulfillment system 210 of FIG. 2), following declaration of a winner of the promotional activity. In other representative embodiments of the present invention, the information identifying the winner of a promotional activity may, for example, be provided by a promotional activity management system (e.g., promotional activity management system 220) to the prize selection system (e.g., the prize selection system 210) following declaration of a winner, and the prize selection system may then provide the information identifying the winner to the product order fulfillment system (e.g., the product order fulfillment system 210 of FIG. 2), to enable delivery of the prize product. In some representative embodiments of the present invention, systems such as the product order fulfillment system 210, the promotional activity management system 220, and the prize selection system 230 may use a common “promotional activity identifier,” to enable the three systems to identify, in communications with one another, the promotional activity to which the communication relates. Such a promotional activity identifier may be assigned by, for example, a system such as the promotional activity management system 220 of FIG. 2.

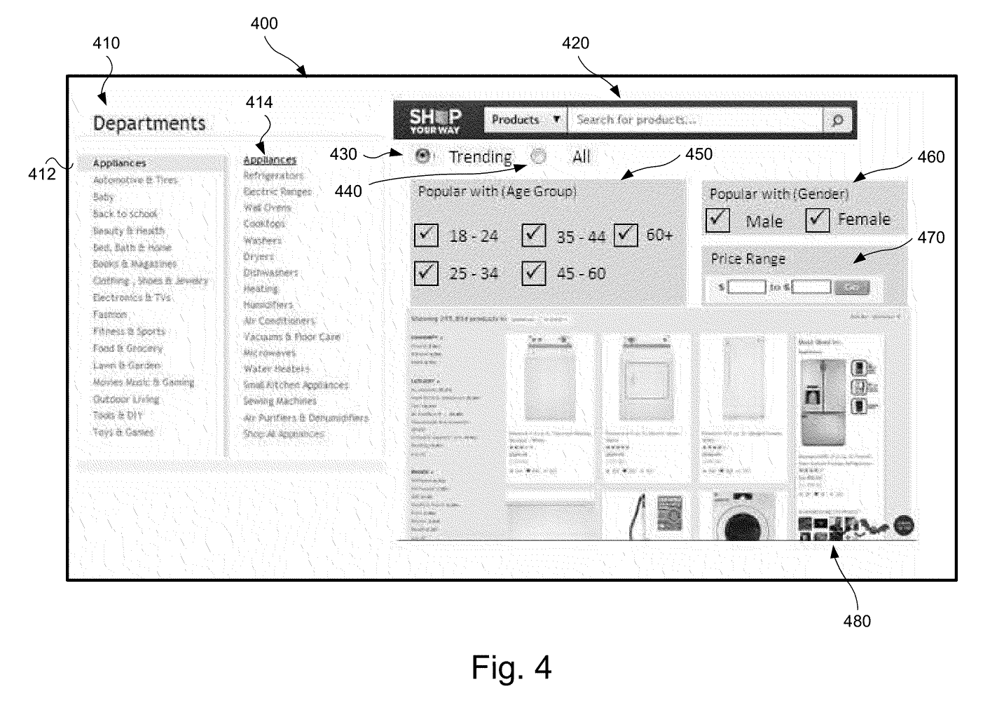

FIG. 4 illustrates a screen image 400 showing an exemplary user interface that enables specification of prize selection parameters for use by a prize selection system such as the prize selection system 230 of FIG. 2, in accordance with a representative embodiment of the present invention. The illustration of FIG. 4 includes a “Departments” portion 410 for the selection of the product category of a prize. In the example of FIG. 4, the “Appliance” department is shown as having been selected, and the operator of the prize selection system 230 may specify a particular product group or category within the “Appliance” department 414, from within which the prize product is to be selected. The user interface of FIG. 4 also includes radio buttons 430, 440 to enable the operator to specify that the prize be selected by the prize selection system from those products of the specified product category that are currently trending, or to include all products in the specified product category, respectively. The radio buttons 430, 440 are provided as another filtering mechanism for the types of prizes displayed in the search result portion 480. The “Trending” radio button 430 may be clicked-on/selected to filter for trending products in the selected product category as the primary choice for display to the operator, and selection by the system. The “All” radio button 440 of FIG. 4 may be used to turn off the filtering and display of trending products, and to enable the display of all possible prizes from the selected category. It should be noted that the examples of search filtering shown in FIG. 4, such as the example use of radio buttons 430, 440 may be expanded to include a greater variety of filter criteria, and that filter criteria may be offered to the operator of the prize selection system 230 using other forms of user interface elements such as, by way of example and not limitation, a dropdown box, a menu, or another graphical or any other suitable form of user interface element, without departing from the spirit of the present invention. In addition, additional filter criteria may permit the operator to select products as prizes for a promotional activity from holiday trends, gift trends, and any other areas of trending delineation that are possible.

The illustration of FIG. 4 also includes an age group filter portion 450 that permits the operator to specify the age group(s) for which trend information is to be used in prize product selection. In addition, a gender filter portion 460 permits the operator to specify whether trend information for male consumers or female consumers is to be used in prize product selection. The illustration of FIG. 4 also shows a prize price filter portion 470, to enable the operator to specify the range of product prices from which a prize is to be selected. The operator may also enter product search criteria in a search box 420, to limit the search for products to those matching the operator-provided search criteria. Finally, the example of FIG. 4 includes a search results portion 480, used to display information about whatever products have been found in the inventory of a system such as the product order fulfillment system 210 of FIG. 2 that pass the filters and criteria specified by the operator using the operator controls of the exemplary user interface of FIG. 4.

Aspects of the present invention may be found in a method of operating a system for automatically selecting a product for use as a prize in a targeted promotional activity from a plurality of available products. Such a method may comprise receiving information representative of a prize product category, a prize product cost, and one or more characteristics of a target participant in the promotional activity, from a system managing the promotional activity. The method may also comprise selecting a set of one or more products from an inventory of a product order fulfillment system, where each product of the set has an associated product category that meets a first condition with regard to the prize product category, and has an associated product price that meets a second condition with regard to the prize product cost. The method may further comprise accessing information representative of a level of consumer interest associated with each product of the set of one or more products, where the level of consumer interest associated with each product is representative only of consumers matching the one or more characteristics of the target participant, and selecting a product from the set of one or more products as the prize, according to the level of consumer interest associated with each product of the set of one or more products. The method may also comprise transmitting information identifying the selected product, to the system managing the promotional activity, and transmitting an order identifying the selected product, to the product order fulfillment system.

In various representative embodiments of the present invention, the one or more characteristics of the target participant may comprise one or more of a gender, an age, a level of income, a marital status, and a stage of life. The order may comprise an indication to the product order fulfillment system to hold the selected product for delivery until receipt of information identifying a winner from the system managing the promotional activity. The promotional activity may comprise one of a contest, a sweepstakes, a giveaway, and an instant win. The product order fulfillment system may comprise an e-commerce platform that processes retail purchases by, and social network communication between members of a loyalty program of a merchant, via a public data network. The first condition may comprise the associated product category matching the prize product category. The prize product cost may be represented as a cost range, and the second condition comprises the associated product price being within the cost range. The information representative of a level of consumer interest may be generated by the product order fulfillment system using consumer shopping activity. The product category may be representative of products in a particular department of a retail merchant.

Additional aspects of the present invention may be seen in a system for automatically selecting a product for use as a prize in a targeted promotional activity from a plurality of available products. Such a system may comprise at least one processor for communicatively coupling to a system for managing a promotional activity and to a system for fulfilling orders for products, where the at least one processor is operable to, at least, perform the actions of the method described above.

Further aspects of the present invention may be observed in a non-transitory computer-readable medium having a plurality of code sections, where each code section comprises a plurality of instructions executable by one or more processors to perform actions for automatically selecting a product for use as a prize in a targeted promotional activity from a plurality of available products, the actions of the one or more processors comprise the actions of the method described above.

Although devices, methods, and systems according to the present invention may have been described in connection with a preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of operating a system for automatically selecting a product for use as a prize in a targeted promotional activity from a plurality of available products, the method comprising:
receiving information representative of a prize product category, a prize product cost, and one or more characteristics of a target participant in the promotional activity, from a system managing the promotional activity;
selecting a set of one or more products from an inventory of a product order fulfillment system, wherein each product of the set has an associated product category that meets a first condition with regard to the prize product category, and has an associated product price that meets a second condition with regard to the prize product cost;
accessing information representative of a level of consumer interest associated with each product of the set of one or more products, wherein the level of consumer interest associated with each product is representative only of consumers matching the one or more characteristics of the target participant;
selecting a product from the set of one or more products as the prize, according to the level of consumer interest associated with each product of the set of one or more products;
transmitting information identifying the selected product, to the system managing the promotional activity; and
transmitting an order identifying the selected product, to the product order fulfillment system.

2. The method according to claim 1, where the one or more characteristics of the target participant comprise one or more of a gender, an age, a level of income, a marital status, and a stage of life.

3. The method according to claim 1, wherein the order comprises an indication to the product order fulfillment system to hold the selected product for delivery until receipt of information identifying a winner from the system managing the promotional activity.

4. The method according to claim 1, wherein the promotional activity comprises one of a contest, a sweepstakes, a giveaway, and an instant win.

5. The method according to claim 1, wherein the product order fulfillment system comprises an e-commerce platform that processes retail purchases by, and social network communication between members of a loyalty program of a merchant, via a public data network.

6. The method according to claim 5, wherein the first condition comprises the associated product category matching the prize product category.

7. The method according to claim 5, wherein the prize product cost is represented as a cost range, and the second condition comprises the associated product price being within the cost range.

8. The method according to claim 1, wherein the information representative of a level of consumer interest is generated by the product order fulfillment system using consumer shopping activity.

9. The method according to claim 1, wherein the product category is representative of products in a particular department of a retail merchant.

10. A system for automatically selecting a product for use as a prize in a targeted promotional activity from a plurality of available products, the system comprising:
at least one processor for communicatively coupling to a system for managing a promotional activity and to a system for fulfilling orders for products, wherein the at least one processor is operable to, at least:
receiving information representative of a prize product category, a prize product cost, and one or more characteristics of a target participant in the promotional activity, from the system managing the promotional activity;
selecting a set of one or more products from an inventory of the product order fulfillment system, wherein each product of the set has an associated product category that meets a first condition with regard to the prize product category, and has an associated product price that meets a second condition with regard to the prize product cost;
accessing information representative of a level of consumer interest associated with each product of the set of one or more products, wherein the level of consumer interest associated with each product is representative only of consumers matching the one or more characteristics of the target participant;
selecting a product from the set of one or more products as the prize, according to the level of consumer interest associated with each product of the set of one or more products;
transmitting information identifying the selected product, to the system managing the promotional activity; and
transmitting an order identifying the selected product, to the product order fulfillment system.

11. The system according to claim 10, where the one or more characteristics of the target participant comprise one or more of a gender, an age, a level of income, a marital status, and a stage of life.

12. The system according to claim 10, wherein the order comprises an indication to the product order fulfillment system to hold the selected product for delivery until receipt of information identifying a winner from the system managing the promotional activity.

13. The system according to claim 10, wherein the promotional activity comprises one of a contest, a sweepstakes, a giveaway, and an instant win.

14. The system according to claim 10, wherein the product order fulfillment system comprises an e-commerce platform that processes retail purchases by, and social network communication between members of a loyalty program of a merchant, via a public data network.

15. The system according to claim 14, wherein the first condition comprises the associated product category matching the prize product category.

16. The system according to claim 14, wherein the prize product cost is represented as a cost range, and the second condition comprises the associated product price being within the cost range.

17. The method according to claim 10, wherein the information representative of a level of consumer interest is generated by the product order fulfillment system using consumer shopping activity.

18. A non-transitory computer-readable medium having a plurality of code sections, each code section comprising a plurality of instructions executable by one or more processors to perform actions for automatically selecting a product for use as a prize in a targeted promotional activity from a plurality of available products, the actions of the one or more processors comprising:
receiving information representative of a prize product category, a prize product cost, and one or more characteristics of a target participant in the promotional activity, from a system managing the promotional activity;
selecting a set of one or more products from an inventory of a product order fulfillment system, wherein each product of the set has an associated product category that meets a first condition with regard to the prize product category, and has an associated product price that meets a second condition with regard to the prize product cost;
accessing information representative of a level of consumer interest associated with each product of the set of one or more products, wherein the level of consumer interest associated with each product is representative only of consumers matching the one or more characteristics of the target participant;
selecting a product from the set of one or more products as the prize, according to the level of consumer interest associated with each product of the set of one or more products;
transmitting information identifying the selected product, to the system managing the promotional activity; and
transmitting an order identifying the selected product, to the product order fulfillment system.

19. The non-transitory computer-readable medium according to claim 18, where the one or more characteristics of the target participant comprise one or more of a gender, an age, a level of income, a marital status, and a stage of life.

20. The non-transitory computer-readable medium according to claim 18, wherein the order comprises an indication to the product order fulfillment system to hold the selected product for delivery until receipt of information identifying a winner from the system managing the promotional activity.

21. The non-transitory computer-readable medium according to claim 18, wherein the promotional activity comprises one of a contest, a sweepstakes, a giveaway, and an instant win.

22. The non-transitory computer-readable medium according to claim 18, wherein the product order fulfillment system comprises an e-commerce platform that processes retail purchases by, and social network communication between members of a loyalty program of a merchant, via a public data network.

23. The non-transitory computer-readable medium according to claim 22, wherein the first condition comprises the associated product category matching the prize product category.

24. The non-transitory computer-readable medium according to claim 22, wherein the prize product cost is represented as a cost range, and the second condition comprises the associated product price being within the cost range.

25. The non-transitory computer-readable medium according to claim 22, wherein the information representative of a level of consumer interest is generated by the product order fulfillment system using consumer shopping activity.
